(19) United States
(12) Patent Application Publication
(10) Pub. No.: US 2009/0237305 A1
(43) Pub. Date: Sep. 24, 2009

(54) Wireless location and attitude detector for a sensor

(76) Inventor: Christopher John Rudolph, Columbus, MN (US)

Correspondence Address: Christopher John Rudolph, 5120 197th Ave NE, Wyoming, MN, 55092, US

(21) Appl. No.: 12/077,937

(22) Filed: Mar. 24, 2008

(51) Int. Cl. G01S 3/02

(52) U.S. Cl. 342/463

(57) ABSTRACT

The present invention, a wireless location and attitude detector for a sensor, is intended to determine and record the position and attitude of a sensor being used to test a material. It uses radio frequency identification transponders attached to a rigid object, to which the sensor is also attached. These radio frequency identification transponders respond to radio frequency identification transceivers that measure the time of response, giving distance data for each radio frequency identification transponder. This data is calculated to establish the position and attitude of the sensor relative to the radio frequency identification transceivers. This recorded data is used by a computer to draw a contoured image of the material, as the sensor is being dragged across the material by hand. This material contour image can be combined with data from the sensor itself for the purpose of drawing an image of a tested material that shows characteristics of the material on the image. This can be done without a rigid connection of the sensor to the position recording apparatus.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

Many types of position and attitude detection systems exist for the use of recording information about the positioning of many types of sensor. The sensor is rigidly connected to a mechanical position detection system, which sends information about the position and attitude of the sensor to a computer. The computer records this information.

The sensor is also connected by wire to a testing machine, and sends to it some type of information about a characteristic of a material to the testing machine. Such machines include temperature, ultrasonic flaw detection, and eddy current flaw detection testing machines. The information from these machines is sent to a computer, which combines it with the positioning information. This gives an image of the characteristics of the material for interpretation by practitioners.

This type of system currently exists with position encoding devices that require rigid physical contact with the sensor. They are extremely bulky, difficult to use, and inaccurate. The geometry of the material frequently makes use of the devices impossible.

A system that does not require rigid connection of the sensor to the position and attitude detector is needed. In this way, odd geometries of the material being tested can be followed by hand or other means, while sending the same position and attitude information to the computer.

### BRIEF SUMMARY OF THE INVENTION

Radio Frequency Identification systems use very small transponders that receive and transmit electromagnetic energy in the form of radio waves. Each transponder has its own identification built in. It responds only to radio signals from a transceiver that sends radio signals of the correct frequency and modulation. The transceiver sends a signal and receives a signal back from the transponder, with the transponders own identification. This is mainly used to identify consumer products on inventory shelves.

A collection of radio frequency identification transponders fixed onto a rigid object may also be used to communicate with an array of transceivers in order to send positioning information about the object. The transceivers measure the amount of time it takes for the signal from each transponder to return. The distance of each transponder from the transceiver may then be compared by a computer program. The program uses logic to calculate the attitude of the object, and its distance from the transceiver. It then records this information, and continues to calculate received signals, recording the attitude and position of the object several times per second.

The relative position of the transceivers must be entered into the computer ahead of time. Also, the relative position of the transponders on the rigid object must be entered into the computer ahead of time. In this way, the computer can record the entire path of any portion of the object from a selected start time to finish time.

This information is especially useful when combined with information generated by a sensor attached to the object itself. Types of sensor may be, but are not limited to, temperature, electromagnetic induction (eddy current), ultrasonic. This sensor, attached by wire to testing machines, provides information about the characteristics of a material. When the information gathered by the testing machine is also sent to a computer, and that information is combined with the positioning data from the radio frequency identification system, a three-dimensional picture of the character of the material is created.

This system also works with a simple probe that is used to touch the material, and give only dimensional information about it.

### BRIEF DESCRIPTION OF THE SEVERAL VIEWS OF THE DRAWING

In the accompanying drawings:

FIG. 1 is a view from the side of a preferred embodiment of a Wireless Location and Attitude Detector for a Sensor of the instant invention.

FIG. 2 is a view of the end of a Wireless Location and Attitude Detector for a sensor of the instant invention.

FIG. 3 is an array of radio frequency identification transceivers attached to a frame with wires leading to a controller, which triggers them, and then times the response that the transceivers receive from the radio frequency identification transponders.

### DETAILED DESCRIPTION OF THE INVENTION

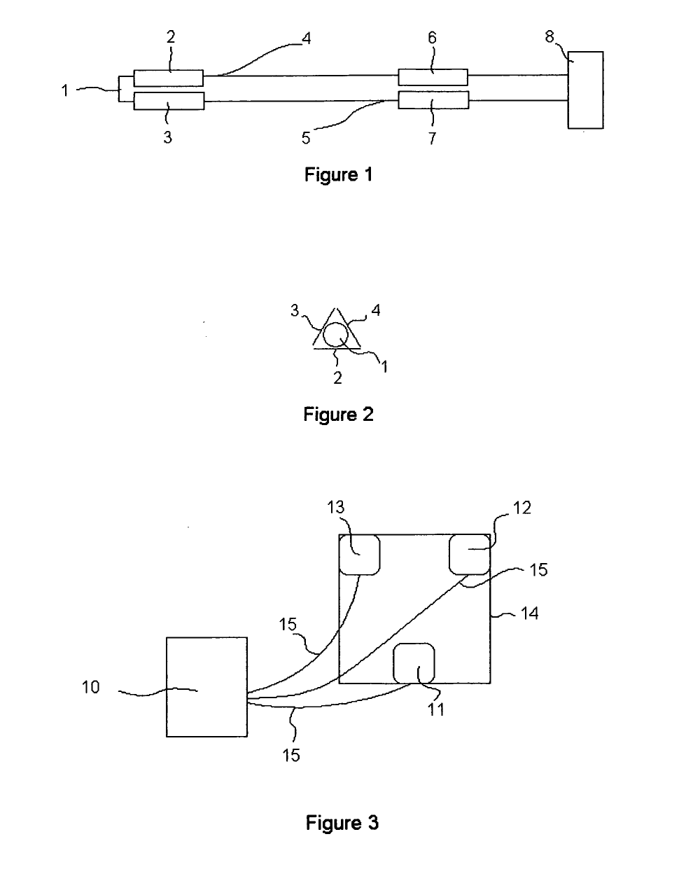

Looking more particularly to the drawings, there is shown in FIG. 1 a preferred embodiment of the Wireless Location and Attitude Detector for a Sensor.

As seen in FIG. 1, the rigid object, has a plurality of radio frequency identification transponders 2 through 7 attached to it (transponders 4 and 5 being obscured from view), with a sensor 8 at the end of said object. The number of radio frequency identification transponders may be as few as one, depending on the need for position and attitude information. The instant rigid object may vary in shape from that shown.

As seen in FIG. 2, a plurality of said radio frequency identification transponders may be attached around said object to afford more attitude information.

As seen in FIG. 3, a plurality of radio frequency identification transceivers 11, 12, and 13 may be attached to a frame 14, and connected by wires 15 to a controller 10. Once the relative locations of said transceivers on said frame and said radio frequency identification transponders on said object are input into said controller, said controller may be used to send radio signals from said transceivers to said radio frequency identification transponders and measure the time of responses from said radio frequency identification transponders to said transceivers. Said transceiver may then send said response times to a computer, which is not shown on the figure, to calculate the relative position and attitude of said sensor on said rigid object.

According to the teachings of the instant invention disclosed herein, the applicant fabricated a working single-transponder prototype from readily available materials, and has actually reduced the invention to practice with favorable results.

The instant invention provides an added advantage and recognizes a problem and adequately and completely addresses an unfulfilled need, in that the instant invention, in the manner disclosed here, provides a means of providing relative position and attitude information from a sensor without rigid attachment of said sensor to position encoding devices.

A wide variety of further uses and advantages of the present invention will become apparent to one skilled in the art. One skilled in the art will realize that the foregoing discussion outlines the more important features of the invention to enable a better understanding of the instant invention and to instill a better appreciation of the inventor's contribution to the art. It must be clear that the disclosed details of construction, descriptions of geometry and illustrations of inventive concepts are only examples of possible manifestations of the invention.

Although the invention has been shown and described with reference to certain preferred embodiments, those skilled in the art will probably find alternative embodiments obvious after reading this disclosure. With this in mind, the following claims are intended to define the scope of protection to be afforded to the inventor, and those claims shall include equivalent constructions insofar as they do not depart from the spirit and scope of the present invention.

1. A wireless location and attitude detector for a sensor, said detector comprising a rigid object to which are attached a plurality of radio frequency identification transponders, said transponders responding to radio signals from a plurality of radio frequency identification transceivers, the time of said response from said radio signals being measured by a controller to determine and record the distance of said radio frequency identification transponders from said radio frequency identification transceivers, a computer program that uses said recorded distances to determine the position and attitude of said rigid object and any sensor attached thereto for the purpose of calculating and recording said sensor position and attitude several times per second, and creating an image from a collection of said positions and attitudes for the purpose of recording the path of said sensor across a material being tested with said sensor.

2. A computer program that receives data from the sensor of claim 1, and combines it with the image of claim 1 for the purpose of characterizing the material of claim 1 without a rigid connection between the sensor of claim 1 and radio frequency transceivers of claim 1 or controller of claim 1.
